(19) United States
(12) Patent Application Publication
(10) Pub. No.: US 2005/0201904 A1
(43) Pub. Date: Sep. 15, 2005

(54) Specimen collection and processing device

(75) Inventors: Terri Stripling, Greenfield, NY (US); Jeffrey Karker, Cazenovia, NY (US); Carl M. Selavka, Sudbury, MA (US); Thomas M. Eden, Birmingham, AL (US)

Correspondence Address: FITZPATRICK CELLA HARPER & SCINTO, 30 ROCKEFELLER PLAZA, NEW YORK, NY, 10112, US

(73) Assignee: DrugRisk Solutions

(21) Appl. No.: 10/999,348

(22) Filed: Nov. 30, 2004

Related U.S. Application Data
(60) Provisional application No. 60/526,404, filed on Dec. 1, 2003.

(51) Int. Cl. B01L 3/00

(52) U.S. Cl. 422/102

(57) ABSTRACT

The present invention is directed to a disposable specimen collection device comprising a specimen chamber, a closing element and a cutting element. The specimen is preferably hair or feathers and the device is preferably used for extracting analytes from the specimen.

### CROSS REFERENCE TO RELATED APPLICATIONS

This application claims priority under 35 U.S.C. § 119(e) to U.S. Provisional Application No. 60/526,404, filed Dec. 1, 2003.

### BACKGROUND OF THE INVENTION

1. Field of the Invention

This invention relates to a disposable specimen collection device that allows for the rapid and precise collection of a specimen such as hair or feathers for further processing and analysis

2. Related Art

The extraction of analytes from samples from humans and animals, such as hair or feathers, is desirable for many reasons. For example, the extraction of analytes from human samples can allow for testing of drugs of abuse and steroids. In addition, the extraction of analytes from animal samples can allow for the testing of analytes such as pesticides, herbicides, antibiotics, steroids, lead, mercury, etc.

The abuse of drugs in humans has been associated with criminal activities, health problems, newborn addiction, lost worker productivity and high medical costs. Current diagnostic tools for testing for drugs of abuse include urinalysis and radioimmunoassay of hair samples. Urinalysis has potential problems because of the rapid elimination of drugs of abuse in urine resulting in a narrow window for testing. Additional problems with urinalysis are the short half life of drugs of abuse in urine, false negative test results due to sample switching, and false positive test results from cross-reactions with certain medications and foods found in urine. Radioimmunoassays are cumbersome and time consuming and generally cannot easily be performed on-site because they require an experienced technician.

Hair testing however provides several advantages over urine testing. First, it is difficult to evade drug detection with hair analysis because there is a greater time window for drug detection compared to urinalysis. Following deposition in hair, drugs may persist for extended periods of time and thus may provide information on chronic exposure which may not only replace the need for urinalysis but may also complement urinalysis. In addition, the sample can be collected by the person doing the test and tampering is not likely to occur.

U.S. Pat. No. 6,478,750, the disclosure of which is incorporated herein by reference in its entirety, describes a non-disposable hair collection device.

The object of the present invention is to provide a disposable specimen collection and processing device.

### SUMMARY OF THE INVENTION

The present invention relates to a disposable hair collection device. The device, when closed, is preferably shaped like a hollow tube having tapered ends, although variations in shape and ends are appreciated by the skilled artisan. The device may further comprise an end cap. The device allows for the rapid and precise collection, transporting, and storing of a specimen such as hair from a human or animal. The device also decreases specimen handling, decreases risk of contamination, minimizes the likelihood of tampering, and improves the efficiency of specimen collections.

### BRIEF DESCRIPTION OF THE DRAWINGS

Exemplary embodiments of the present invention will now be described in detail with reference to the accompanying figures in which:

FIG. 1A shows a side cross-sectional view of an exemplary embodiment of the device having a hinge;

FIG. 1B shows a side view of an exemplary embodiment of an end cap for the device of FIG. 1A;

FIG. 1C shows a side view of an exemplary embodiment of the device with the end cap of FIG. 1B;

FIG. 1D shows a cross-sectional view through the middle of an exemplary embodiment of the device;

FIG. 2 shows a perspective view of an exemplary embodiment of the device when open;

FIG. 3 shows a side view of an exemplary embodiment of the device;

FIG. 4 shows an end view of an exemplary embodiment of the device;

FIG. 5 shows a front view of an exemplary embodiment of the device;

FIG. 6 shows a back view of an exemplary embodiment of the device;

FIG. 7 shows a perspective view of an exemplary embodiment of an end cap for the device;

FIG. 8 shows a side view of an exemplary embodiment of an end cap for the device;

FIG. 9 shows a side view of a second exemplary embodiment of the device having a hinge that snaps together;

FIG. 10 shows a front view of the device of FIG. 9 when open;

FIG. 11 shows a back view of the device of FIG. 9 when open;

FIG. 12 shows a cross section through a third exemplary embodiment of the device having a hinge with a pin;

FIG. 13 shows a side view of the device of FIG. 12; and

FIG. 14 shows a top view of the device of FIG. 12.

### DETAILED DESCRIPTION OF THE INVENTION

The present invention provides a disposable specimen collection device. The device allows for the collection of a predetermined amount of specimen, such as hair, from a subject for use as a test sample. The length and internal diameter create a volume that is approximately equal to that of the desired sample amount. The device minimizes sample handling, thus maximizing sample integrity. The device may be used for on-site screening of analytes from a specimen. Accordingly, it is useful for detecting the presence of drugs of abuse, hazardous materials, biological agents, organic chemicals, inorganic metallic compounds, tobacco products, therapeutic drugs, steroids, antibiotics, etc.

In a particularly preferred embodiment, analytes of interest may be extracted from the specimen while within the collection device. The extraction of the analytes may be accomplished by various methods, nonlimiting examples of which include supercritical fluid extraction (SFE), pressurized solvent extraction (PSE) or organic solvent extraction. Extraction of analytes may be achieved by charging an extraction reagent that extracts the analytes of interest from the specimen preferably while the specimen is enclosed in the collection device.

In one embodiment, the collection device encloses the specimen and serves as a reservoir through which the extraction reagent, such as supercritical carbon dioxide or hot methanol, flows, entering through one end of the device and eventually exiting through the other end with the analyte of interest entrained in the extraction reagent.

In another embodiment, the extraction reagent enters the collection device and extracts the analytes of interest from the specimen, for example, with the addition of heat or agitation or other energy to speed or enhance the extraction. The extraction reagent may be removed from the collection device by vacuum or positive pressure from a syringe end-cap or other pumping mechanism. The specimen may also be filtered from the extract, which includes the extraction reagent and the analyte of interest, prior to removing the extract from the collection device.

In yet another embodiment, the extraction reagent is included in a reservoir which may be located within the collection device of the invention. The extraction reagent may then be released from the reservoir and allowed to combine with the specimen to effectuate the extraction of analytes from the specimen. The extraction reagent(s) in the reservoir may be in any form desirable, including in liquid form and freeze-dried form and may be released at a desired time during an automated process cycle. If the extraction reagents are in freeze-dried form, they may be reconstituted with a fluid. The reaction reagents in the reservoir may be included in a packet that may be perforated while in the collection device. Perforation of the packet may be accomplished by any means, including, but not limited to, a puncture device that may automatically puncture the packet when the collection device is closed.

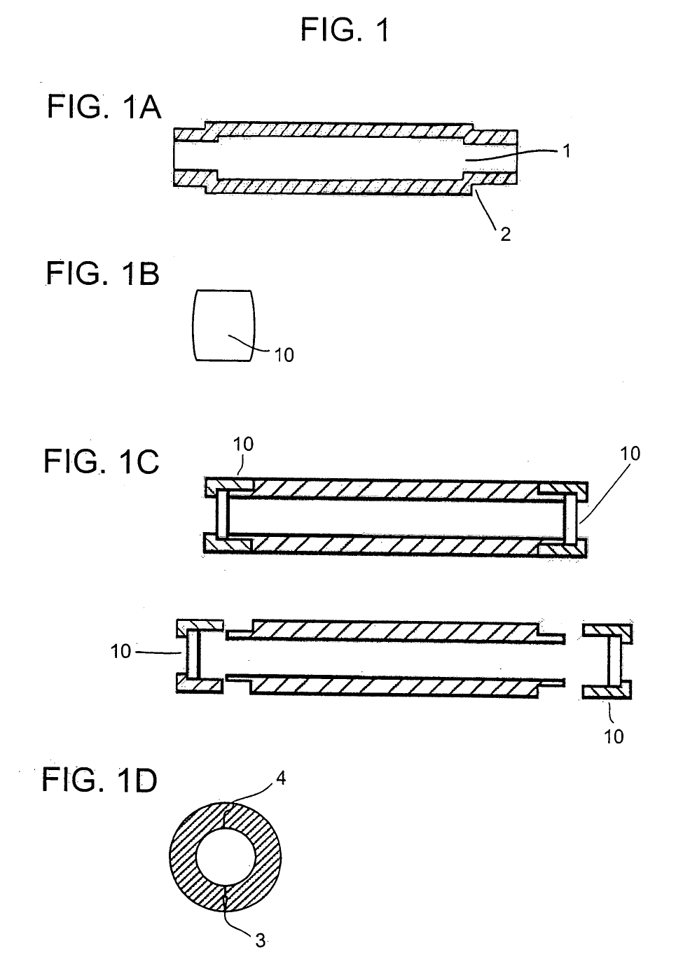

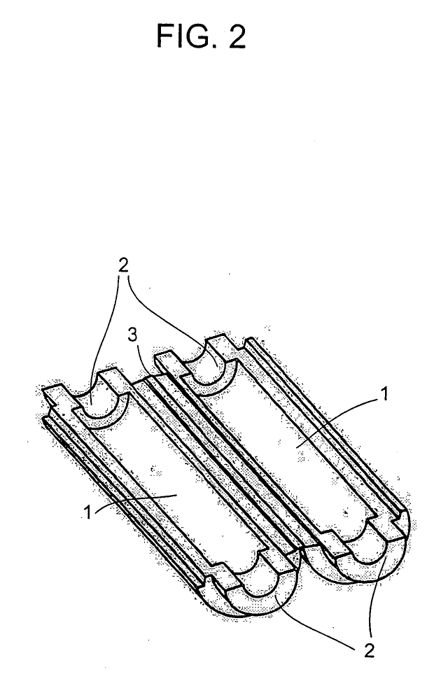

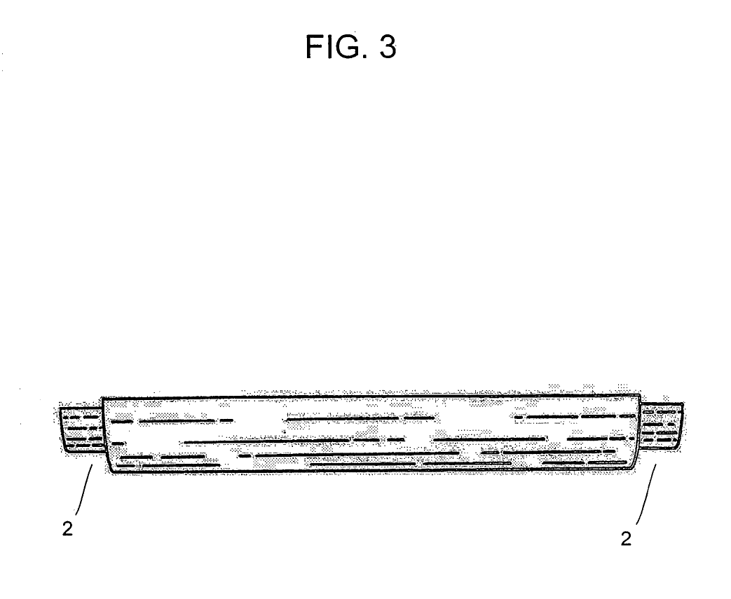

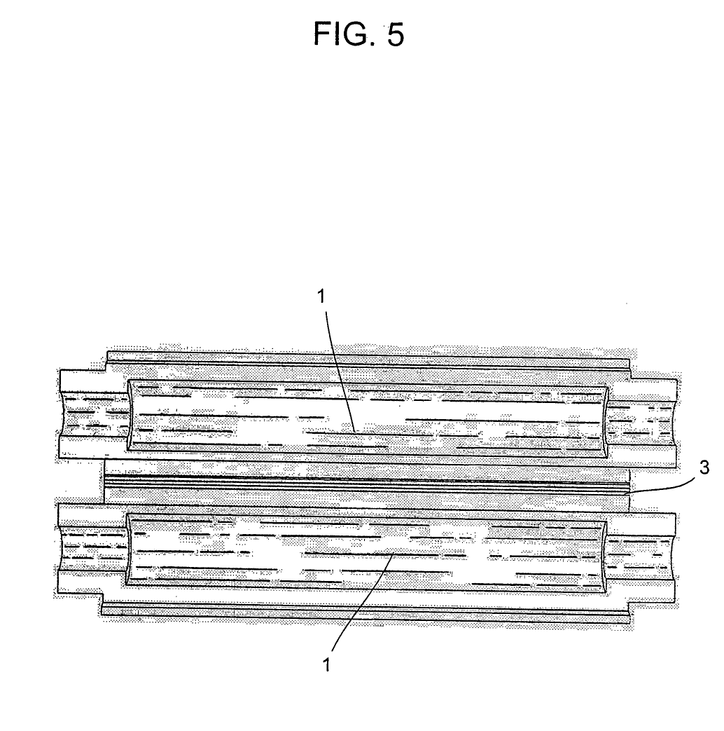

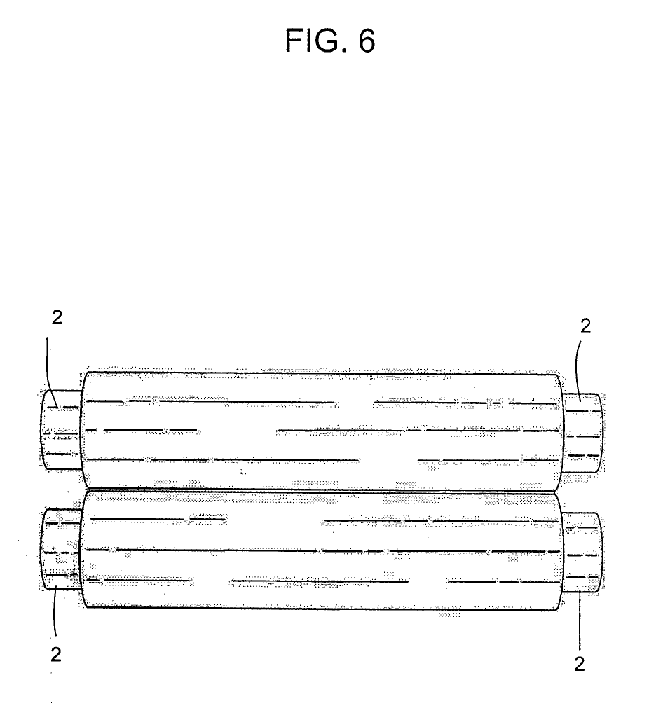

In one embodiment of the invention, as shown in FIG. 1A, the device, when closed, includes a hollow specimen chamber 1, preferably a tube, with tapered ends 2. FIG. 2 and FIG. 5 illustrate the hollow center of the device of the present invention. FIG. 3 and FIG. 6 are side views which depict the tapered ends of the device. The device preferably includes a hinge. FIGS. 1D, 2 and 4 show one exemplary embodiment of a hinge of the present invention. The hinge 3 in FIGS. 1D, 2 and 4 is a “living hinge”. As used herein, a living hinge is a thin flexible web of material that joins two chamber walls, e.g. two rigid bodies, together. Non-limiting examples of living hinges include a fully elastic hinge that is capable of flexing several thousand cycles, a fully plastic hinge that is capable of flexing only a few cycles, and a combination of plastic elastic that is capable of flexing hundreds of times. The material and design of the hinge is dependent on the required life of the hinge, and the ultimate application for which the hinged device is used. In a preferred embodiment, the device is not required to withstand high temperatures, pressures or chemical exposure and can be made from a flexible, non-engineering grade plastic, such as polypropylene or polyethylene.

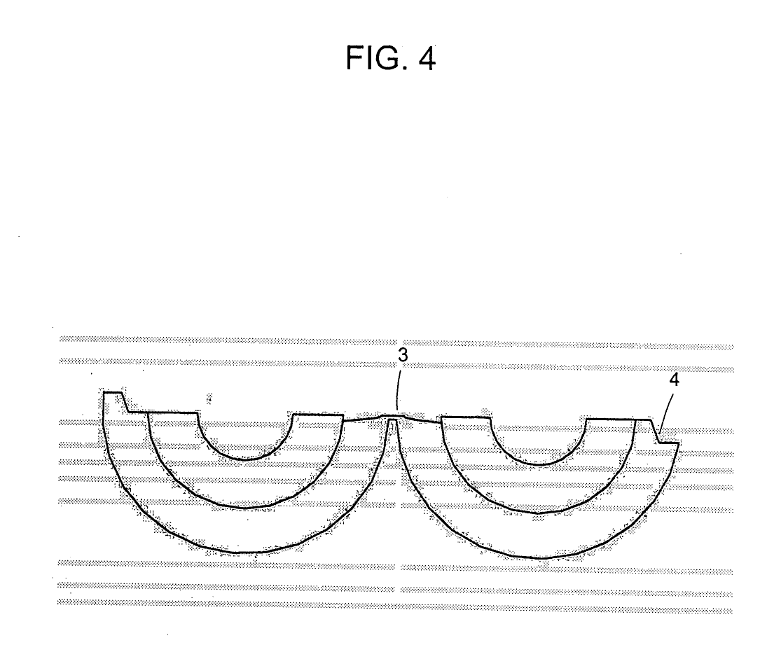

In a preferred embodiment for an alternative application in which the device is intended to withstand higher temperatures, pressures and chemical exposure, the device is made from engineering grade resins. If the device is to be used in post-collection processing, the material specified for the device must withstand all processing parameters for the specified processing duration. The hinge in such an embodiment is a thinner region of material which can be flexed without breaking, such as the thin region of plastic 3 shown in FIG. 4. The device may be formed as a single piece, in which case the hinge is molded as a connection between the two halves of the tube. Alternatively, the device may be molded in two pieces, or barrels, and the hinge may be subsequently added by any means known in the art. In a particularly preferred embodiment, the living hinge may be flexed at least 10 times without breaking.

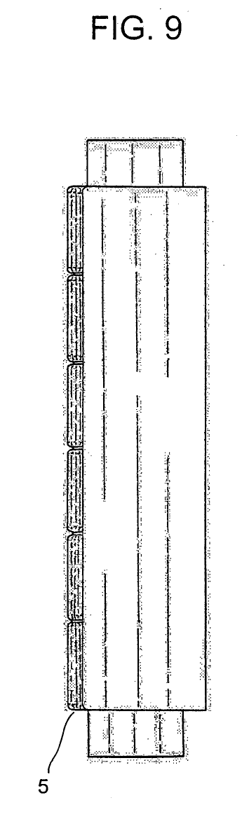

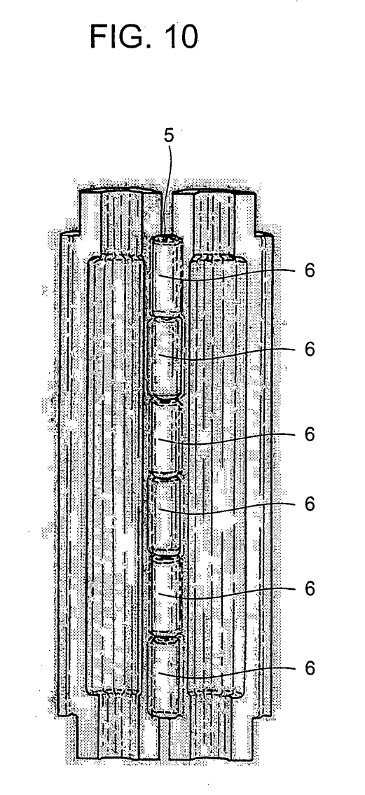

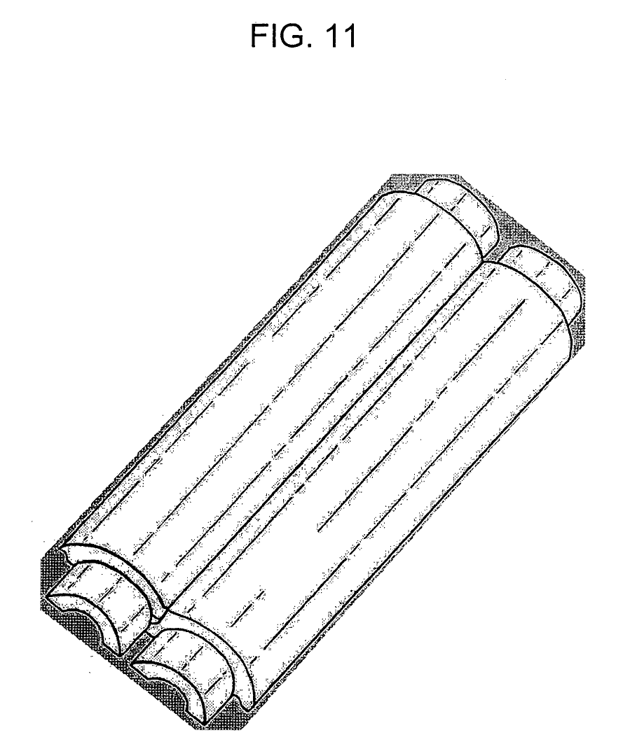

In another embodiment of the device, the hinge may be a “traditional hinge.” As used herein, a traditional hinge is a hinge that snaps together and allows the device to be opened and closed multiple times without breaking. The traditional hinge is more resilient than the living hinge. In this embodiment, the chamber of the device may be formed in at least two separate pieces, or barrels, having matching interlocking elements (i.e. they fit together like the teeth of a zipper) that can be snapped together after formation. FIG. 9 shows a side view of a device of the invention when closed, configured with a traditional hinge 5. FIG. 10 shows a front view of a device of the invention when opened configured with a traditional hinge 5. In FIG. 10, the interlocking elements 6 of the traditional hinge which snap together can be seen. FIG. 11 shows a back view of this embodiment of the invention when the device is open. In this configuration, the traditional hinge is not visible from the back of the opened device.

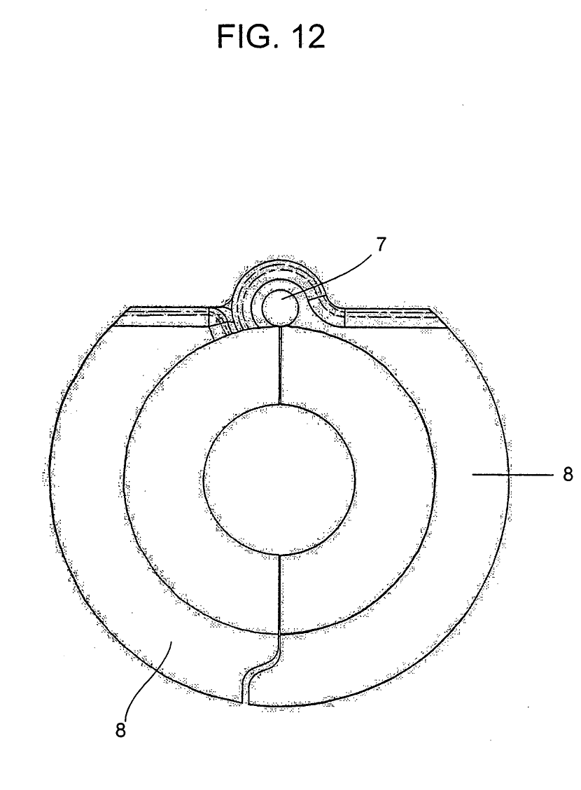

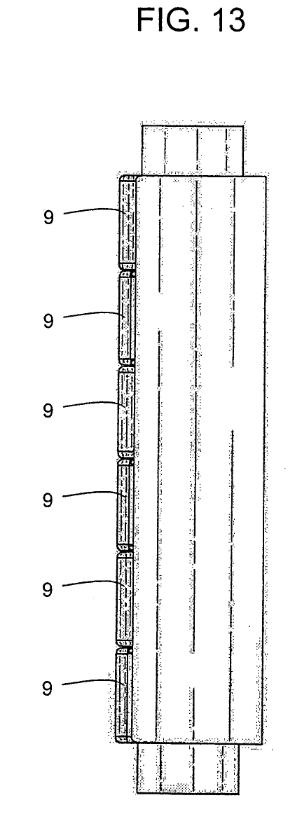

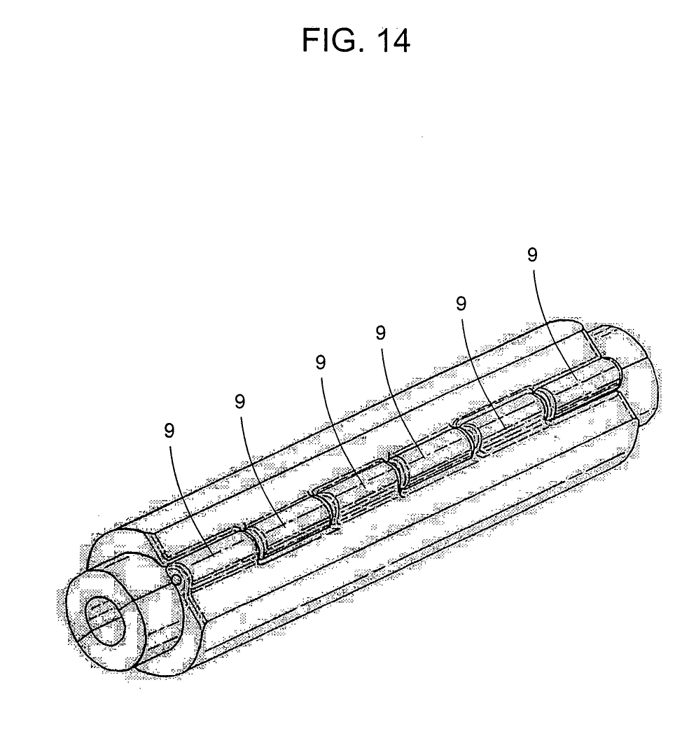

In another embodiment, a hinge with a pin may be used. This embodiment is depicted in FIG. 12-14. FIG. 12 shows a cross sectional view through the center of the device showing the pin 7 which holds the two barrels 8 together. As shown in FIGS. 13 and 14, the hinge includes interlocking elements 9 which are formed with a hole through the center. When the two barrels are put together, the hinge is secured with the pin. The pin-type hinge is also very resilient and may be opened and closed many times.

In yet another embodiment, the device may be formed in two separate barrels with no hinge elements and a securing element, such as tape, may be used to hold the two barrels together on one side of the device. The device may also be formed without any hinges as a single tube.

In another embodiment, the device further comprises a closing element. As shown in FIG. 1D and FIG. 4 a simple undercut 4 along the body of material is used to provide a snap-fitting for the tube closure. End caps, if incorporated, provide closing means and further security for the closure. The closing means may be any means known in the art, such as a spring loaded hinge which closes when the two barrels of the device come within a certain distance of each other.

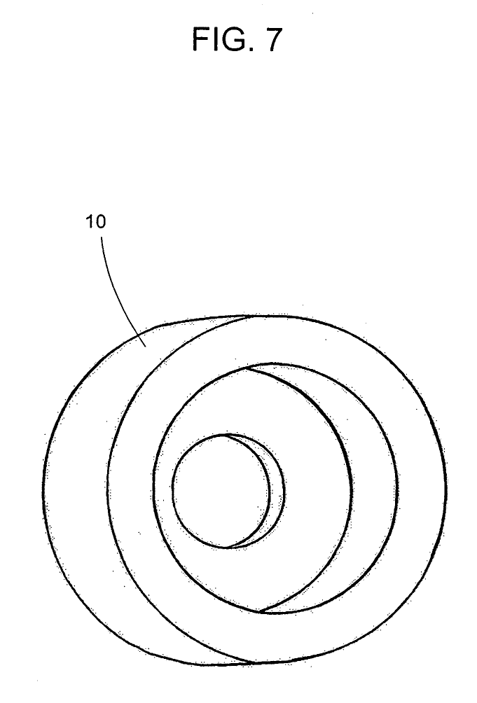

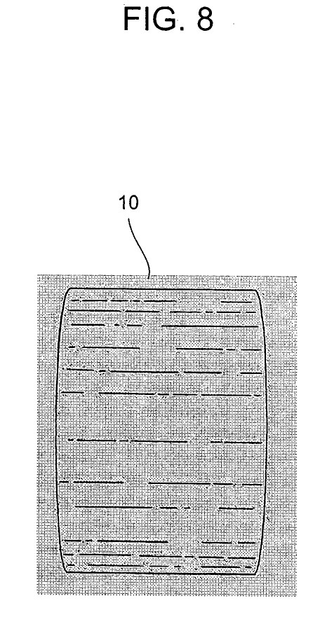

As noted, the device may also comprise at least one end cap. One embodiment of an end cap 10 of the invention is shown in FIGS. 1B, 1C, 7 and 8. The end cap may serve to keep the device closed, in which case the aforementioned closing element may not be required. The end cap may also serve to prepare the device and sample for pulverization, extraction or analysis. In one embodiment, the end cap contains a specimen retaining element, such as, but not limited to, a frit, or micro filter, that allows analytes from the specimen to exit the device while retaining the sample within the device. In another embodiment, the end cap includes a central orifice to allow for the extraction of analytes from the specimen when the device is placed in an extraction or detection device.

In another embodiment, the specimen in the device may be precleaned. This may be accomplished by any means known in the art, for example, with a filter in one end cap through which a cleaning reagent may pass. This may also be accomplished by the incorporation of a sponge-like or fabric/wipe material on the inner diameter that wraps around and holds a cleaning reagent onto the specimen which can then be removed. In a preferred embodiment, a cleaning reagent packet may be included in the device which can be broken upon closure of the device. The device can then be shaken and allowed to stand for a minute. One end cap that incorporates a filter can then be opened and the cleaning reagent and any contaminants can then be poured out. A second wash may also be conducted with water, for example, to remove any residual cleaning reagent and/or contaminants.

In another embodiment, reagents, including extraction reagents, may be stored or located, for example, in the specimen chamber and/or the end caps of the device for subsequent use when a process cycle is initiated. As noted above, the reagents may be in dried, lyophilized (freeze-dried), or in other such states and may be eluted when needed, and may be included in a reservoir, holding chamber, or other appropriate area that may be molded or added into the device or attached to the device to store the reagents.

The device may further comprise an intermediary element, which may be an external apparatus, instrument, or equivalent device to assist in the collection of the specimen. Such an intermediary element may be a device that adapts to the subject's place of collection, such as the animal's tail or neck, and serves to hold the collection device so as to capture the desired amount of specimen from the subject or to aid in placing the specimen in the collection tube or to aid in closing the device and/or excising the specimen. In one embodiment, the intermediary device is a molded plastic handheld apparatus that allows for the collection device to be placed at pre-determined distance from the subject's collection surface (skin) to consistently capture the desired length and volume of hair. In another embodiment, the intermediary element is an external element having a self-actuating (closing) hinge. The collection device would sit open on the face of the external element (e.g., the external element may sit or fasten onto the donor or in the hand of the collector). The external device increases the surface area that requires manipulation. The external device closes with little applied pressure, also closing the collection device that does not have a self-actuating hinge.

In other embodiments, the device has an aspect ratio (length to width), which may vary and be less than or greater than 1 depending on the amount of specimen required or available. The device may also be constructed in shapes or geometric forms other than a cylinder such as, but not limited to, square, rectangular, or oval.

In another embodiment the device itself may be subjected to a process that is the same or a different process to aid in the preparation of the specimen for subsequent analysis. Nonlimiting process examples include pulverization, comminution, dissolution, etc. The device may be made of such a material that it can be processed in a manner similar to the specimen that it encloses. For example, if the specimen is to be comminuted or pulverized, the collection device is also comminuted or pulverized so that the original specimen, as well as the material of the collection device, is introduced to an extraction apparatus. In another example, the collection device may be made of a dissolvable material, such as a thick paper, and may be dissolved with the specimen rather than comminuted.

The device may further comprise a specimen assisting mechanism, such as a plunger, which may be integrated into the device or used externally to improve the collection efficiency or to move the specimen into another chamber or into another process area. One embodiment of an integrated assisting mechanism is a plunger mechanism which can be included in the end caps and can push the sample out of the device.

The dimensions of the device are chosen based on the desired sample size. In a particularly preferred embodiment of the invention, the dimensions of the device are approximately 1.5 inches in length and 0.200 inches in inner diameter.

The device of the present invention is used to collect and/or store and/or transport a specimen, such as hair or feathers. The device allows for the precise and rapid collection of the specimen. In a preferred embodiment, the device is in the opened position and hair or feather is placed on top of one barrel of the device. The device is then closed to capture a set specimen size. In a preferred embodiment, the device collects from about 10-20 hairs of about 1.5 inches in length. The sample may be cut at the ends of the device after the device is closed by any means known in the art, such as a razor or a scissors. Alternatively, the device may comprise a cutting element, such as a knife, blade, clipper, shaver, mulcher, etc. In addition, the device may be connected to an external cutting means.

In a further embodiment, a vacuum may be used to facilitate specimen collection, excising, comminution, and pulverization for a subsequent analyte extraction process and/or detection device. In one embodiment, a vacuum is used during the collection. In another embodiment, a vacuum may be used in the subsequent processing or moving of hair from the collection device, as noted above. For the purpose of collection, a vacuum hose or tube may be connected to one end of the collection device and is used to ‘suck’ the hair into the collection device. When a vacuum is used to facilitate specimen processing after collection, one end of the collection device may be attached to a tube (or directly to the vacuum) that is connected to a vacuum (or positive pressure) force. The specimen is moved from the collection device under the vacuum, into a chamber or other vessel. This chamber or other vessel may then be used to comminute the specimen or extract the specimen. The vacuum may not be the main mode of moving the specimen, e.g. hair, from one location to another, but may aid in collecting fines, or the small pieces of hair that may otherwise be lost (remaining in the original vessel or ‘floating’ into the air). This chamber or vessel may hold the specimen and introduce it to another device that prepares the specimen for yet another process. For example, the collection device may introduce the specimen, by incorporating a plunger on the end-cap, to a comminution device which then introduces the specimen to an extraction device.

When the device is formed as a single tube, the specimen may be collected by pulling the hair through the device with, for example, a tweezers or another means resembling a crocheting needle. The sample may then be cut by any means known in the art.

Once the specimen has been collected, the collection device of the present invention may be subjected to a comminution, pulverizing, or digestion device or process to increase the surface area of the sample to facilitate extraction and/or detection of analytics in the sample.

In addition, after specimen collection, the device may be transferred to a detection or extraction apparatus, or subjected to an extraction process which may extract analyte from the specimen and/or may detect analyte within the specimen. An example of an extraction process is described in U.S. patent application Ser. No. 10/840,016, filed on May 5, 2004, the entire disclosure of which is incorporated herein by reference. An example of an extraction apparatus is described in Provisional Patent Application No. 60/520,403, filed on Dec. 1, 2003, the entire disclosure of which is incorporated herein by reference.

1. A disposable device for the collection of a specimen comprising a hollow chamber, a closing element and a cutting element.

2. The device according to claim 1, wherein said chamber has tapered ends.

3. The device according to claim 1, wherein the chamber is formed by at least two walls joined together by a hinge.

4. The device according to claim 3, wherein the hinge is selected from the group consisting of a living hinge, a traditional hinge and a hinge with a pin.

5. The device according to claim 4, wherein the living hinge is selected from the group consisting of an elastic hinge, a plastic hinge, and combinations thereof.

6. The disposable device according to claim 1, wherein the closing element is selected from the group consisting of tape, a snap fitting, a spring-loaded hinge, and an end cap.

7. The disposable device according to claim 1, further comprising at least one end cap.

8. The device according to claim 7, wherein the end cap further comprises a specimen retaining element.

9. The device according to claim 8, wherein the specimen retaining element is selected from the group consisting of a frit and a microfilter.

10. The device according to claim 9, wherein the end cap further comprises an orifice which allows for the extraction of analytes from the specimen.

11. The device according to claim 1, further comprising at least one reagent.

12. The device according to claim 11, wherein the at least one reagent extracts analyte from the specimen.

13. The device according to claim 11, wherein the at least one reagent is located in the specimen chamber.

14. The device according to claim 11, further comprising at least one end cap and wherein the at least one reagent is located in the end cap.

15. The device according to claim 1, further comprising an intermediary element to assist in the collection of the specimen from a subject.

16. The device according to claim 15, wherein the intermediary element holds the disposable device in a location on the subject and allows for collection of a specimen from the subject.

17. The device according to claim 15, wherein the intermediary element aids in placing the specimen in the chamber.

18. The device according to claim 15, wherein the intermediary element aids in closing the device.

19. The device according to claim 15, wherein the intermediary element excises the specimen from the subject.

20. The device according to claim 1, wherein the device has an aspect ratio less than one.

21. The device according to claim 1, wherein the design has an aspect ratio greater than one.

22. The device according to claim 1, wherein the shape of the device is cylindrical.

23. The device according to claim 1, further comprising an assisting mechanism to move the specimen.

24. The device according to claim 23, wherein the assisting mechanism is a plunger.

25. The device according to claim 1, wherein the cutting element is an integrated part of the device.

26. The device according to claim 1, wherein the cutting element is an external cutting element.

27. The device according to claims 25 or 26, wherein the cutting element is selected from the group consisting of a knife, a blade, a clipper, a shaver, and a mulcher.
